(19) United States
(12) Patent Application Publication
(10) Pub. No.: US 2020/0210633 A1
(43) Pub. Date: Jul. 2, 2020

(54) METHOD FOR PREDICTING HIGH-TEMPERATURE FATIGUE SHEAR STRESS IN FIBER/MATRIX INTERFACE OF WOVEN CERAMIC-MATRIX COMPOSITE BY HYSTERESIS DISSIPATED ENERGY

(71) Applicant: Nanjing University of Aeronautics and Astronautics, Nanjing (CN)

(72) Inventor: Longbiao Li, Nanjing (CN)

(21) Appl. No.: 16/551,995

(22) Filed: Aug. 27, 2019

(30) Foreign Application Priority Data
Dec. 29, 2018 (CN) 201811643640.9

(51) Int. Cl. G06F 30/20; G01L 5/00

(52) U.S. Cl. CPC G06F 30/20; G06F 2111/10; G01L 5/00

(57) ABSTRACT

The present invention belongs to the technical field of high-temperature fatigue damage monitoring of materials, and in particular, relates to a method for predicting a high-temperature fatigue shear stress in a fiber/matrix interface of a woven ceramic-matrix composite by a hysteresis dissipated energy. The present invention utilizes a frictional shear stress of an oxidation region at the fiber/matrix interface under a temperature condition, a shear stress of the fiber/matrix interface related to a temperature and a cycle number, and the length of the oxidation region at the fiber/matrix interface to establish a debonding length equation of the fiber/matrix interface for the woven ceramic-matrix composite. Based on this, a fatigue dissipated energy equation is obtained for the woven ceramic-matrix composite, to predict the high-temperature fatigue shear stress in the fiber/matrix interface of the woven ceramic-matrix composite. The foregoing prediction method provided by the present invention fully considers the influence of the temperature and oxidation on the matrix and the fiber/matrix interface of the composite, so that the predicted high-temperature fatigue shear stress in the fiber/matrix interface of the composite is more accurate.

### CROSS REFERENCE TO RELATED APPLICATIONS

This application claims priority to Chinese application number 201811643640.9, filed Dec. 29, 2018, with a title of METHOD FOR PREDICTING HIGH-TEMPERATURE FATIGUE SHEAR STRESS IN FIBER/MATRIX INTERFACE OF WOVEN CERAMIC-MATRIX COMPOSITE BY HYSTERESIS DISSIPATED ENERGY. The above-mentioned patent application is incorporated herein by reference in its entirety.

### TECHNICAL FIELD

The present invention belongs to the technical field of fatigue life prediction of composites, and in particular, relates to a method for predicting a high-temperature fatigue shear stress in a fiber/matrix interface of a woven ceramic-matrix composite by a hysteresis dissipated energy.

### BACKGROUND

Woven ceramic-matrix composites have the advantages of high-temperature resistance, corrosion resistance, low density, high specific strength, and high specific modulus, etc. Compared with high-temperature alloys, they can withstand higher temperatures, reduce cooling airflows, and improve the turbine efficiency. Now they have been applied to the combustion chambers, turbine guide vanes, turbine shroud rings and exhaust nozzles of aero engines, etc. Leading Edge Aviation Propulsion (LEAP) series engines developed by CFM International use high-speed turbines with woven ceramic-matrix composite components. LEAP-1B engines provide power for Airbus A320 and Boeing 737MAX, and LEAP-X1C engines are the only power unit chosen by C919, a large aircraft in China.

In order to ensure the reliability and safety of the woven ceramic-matrix composites used in aircraft and aero engine hot-section structures, many researchers have developed ceramic-matrix composite performance evaluation, damage evolution, strength and life prediction tools as a key to the airworthiness certification of ceramic-matrix composite structural components. The fatigue life of the woven ceramic-matrix composites has a direct impact on the safety of the materials in use. How to accurately predict the high-temperature fatigue shear stress in the fiber/matrix interface of the woven ceramic-matrix composites is a key to ensuring the reliability and safety of the composites in use.

### SUMMARY

An objective of the present invention is to provide a method for predicting a high-temperature fatigue shear stress in a fiber/matrix interface of a woven ceramic-matrix composite by a hysteresis dissipated energy, and the method provided by the present invention incorporates the influence of a high-temperature environment and oxidation into the predication process, to improve the accuracy of the prediction result of the high-temperature fatigue shear stress in the fiber/matrix interface of the woven ceramic-matrix composites.

To achieve the above purpose, the present invention provides the following technical solution.

A method for predicting a high-temperature fatigue shear stress in a fiber/matrix interface of a woven ceramic-matrix composite by a hysteresis dissipated energy includes the following steps:

(1) based on a shear-lag model, establishing an axial stress distribution equation of a fiber, an axial stress distribution equation of a matrix and a shear stress axial distribution equation of the fiber/matrix interface for the woven ceramic-matrix composite with the matrix cracking and with high-temperature debonding and oxidation at the fiber/matrix interface;

(2) according to an interface debonding criterion of fracture mechanics, establishing a debonding length equation of the fiber/matrix interface by using the shear stress distribution equation of the fiber/matrix interface obtained in the step (1) and the length of an oxidation region at the fiber/matrix interface;

(3) according to the interface debonding criterion of fracture mechanics, a fiber/matrix interface slip mechanism, and the debonding length equation of the fiber/matrix interface obtained in the step (2), establishing an unloading counter slip length equation;

(4) according to the interface debonding criterion of fracture mechanics, the fiber/matrix interface slip mechanism, the debonding length equation of the fiber/matrix interface obtained in the step (2), and the unloading counter slip length equation of the fiber/matrix interface obtained in the step (3), establishing a reloading new slip length equation of the fiber/matrix interface;

(5) according to a micro-stress field of a damage region in the woven ceramic-matrix composite, the debonding length equation of the fiber/matrix interface obtained in the step (2), and the unloading counter slip length equation obtained in the step (3), in combination with a global load sharing criterion, establishing an unloading stress-strain equation;

according to the micro-stress field of the damage region in the woven ceramic-matrix composite, the debonding length equation of the fiber/matrix interface obtained in the step (2), the unloading counter slip length equation obtained in the step (3), and the reloading new slip length equation of the fiber/matrix interface obtained in the step (4), in combination with the global load sharing criterion, establishing a reloading stress-strain equation; and

(6) according to the unloading stress-strain equation and the reloading stress-strain equation obtained in the step (5), establishing a fatigue hysteresis dissipated energy equation, to predict the high-temperature fatigue shear stress in the fiber/matrix interface of the woven ceramic-matrix composite under a different cycle number.

Preferably, the axial stress distribution equation of the fiber in the step (1) is preferably shown in Formula 1-1:

$${σ}_{f} ( x ) = \{ \begin{matrix}\frac{σ}{χ {V}_{f}} - \frac{2 {τ}_{f} ( T )}{{r}_{f}} x , x ∈ [ 0 , ξ ( T ) ] \\ \frac{σ}{χ {V}_{f}} - \frac{2 {τ}_{f} ( T )}{{r}_{f}} ξ ( T ) - \frac{2 {τ}_{i} ( T )}{{r}_{f}} ( x - ξ ( T ) ) , x ∈ [ ξ ( T ) , {l}_{d} ] \\ {σ}_{fo} + [ \frac{{V}_{m}}{χ {V}_{f}} {σ}_{mo} - 2 \frac{{τ}_{f} ( T )}{{r}_{f}} ξ ( T ) - 2 \frac{{τ}_{i} ( T )}{{r}_{f}} ( {l}_{d} - ξ ( T ) ) ] \\ exp ( - ρ \frac{x - {l}_{d}}{{r}_{f}} ) , x ∈ [ {l}_{d} , \frac{{l}_{c}}{2} ]\end{matrix} ; \qquad Formula 1 \text{-} 1$$

the axial stress distribution equation of the matrix is preferably shown in Formula 1-2:

$${σ}_{m} ( x ) = \{ \begin{matrix}2 \frac{χ {V}_{f}}{{V}_{m}} \frac{{τ}_{f} ( T )}{{r}_{f}} x , x ∈ [ 0 , ξ ( T ) ] \\ \begin{matrix}\begin{matrix}2 \frac{χ {V}_{f}}{{V}_{m}} \frac{{τ}_{f} ( T )}{{r}_{f}} ξ ( T ) + 2 \frac{χ {V}_{f}}{{V}_{m}} \frac{{τ}_{i} ( T )}{{r}_{f}} \\ ( x - ξ ( T ) ) , x ∈ [ ξ ( T ) , {l}_{d} ]\end{matrix} \\ {σ}_{mo} - [ \begin{matrix}{σ}_{mo} - 2 \frac{χ {V}_{f}}{{V}_{m}} \frac{{τ}_{f} ( T )}{{r}_{f}} ξ ( T ) - \\ 2 \frac{χ {V}_{f}}{{V}_{m}} \frac{{τ}_{i} ( T )}{{r}_{f}} ( {l}_{d} - ξ ( T ) )\end{matrix} ]\end{matrix} \\ exp ( - ρ \frac{x - {l}_{d}}{{r}_{f}} ) , x ∈ [ {l}_{d} , \frac{{l}_{c}}{2} ]\end{matrix} ; \qquad Formula 1 \text{-} 2$$

the shear stress axial distribution equation of the fiber/matrix interface is preferably shown in Formula 1-3:

$${τ}_{i} ( x ) = \{ \begin{matrix}{τ}_{f} ( T ) , x ∈ [ 0 , ξ ( T ) ] \\ \begin{matrix}{τ}_{i} ( T ) , x ∈ [ ξ ( T ) , {l}_{d} ] \\ \frac{ρ}{2} [ \frac{{V}_{m}}{χ {V}_{f}} {σ}_{mo} - 2 \frac{{τ}_{f} ( T )}{{r}_{f}} ξ ( T ) - \frac{2 {τ}_{i} ( T )}{{r}_{f}} ( {l}_{d} - ξ ( T ) ) ]\end{matrix} \\ exp ( - ρ \frac{x - {l}_{d}}{{r}_{f}} ) , x ∈ [ {l}_{d} , \frac{{l}_{c}}{2} ]\end{matrix} ; \qquad Formula 1 \text{-} 3$$

in the Formulas 1-1, 1-2 and 1-3,

σ_{f}(x) represents an axial stress of the fiber;

σₘ(x) represents an axial stress of the matrix;

σ represents a stress;

σ_{fo} represents an axial stress of the fiber in a bonding region of the fiber/matrix interface;

σₘₒ represents an axial stress of the matrix in the bonding region of the fiber/matrix interface;

Vₘ represents a volume content of the matrix;

χV_{f} represents a volume content of the fiber along a stress loading direction in the woven ceramic-matrix composite;

x represents an axial direction;

τ_{f}(T) represents a frictional shear stress of the oxidation region at the fiber/matrix interface under a temperature condition;

τᵢ(T) represents a frictional shear stress of a slip region at the fiber/matrix interface under a temperature condition;

τᵢ(x) represents an axial stress of the fiber/matrix interface;

ξ(T) represents the length of the oxidation region at the fiber/matrix interface under a temperature condition;

l_{d} represents a debonding length of the fiber/matrix interface;

ρ represents a parameter of the shear-lag model;

r_{f} represents the radius of the fiber;

[0, ξ(T)] represents the oxidation region of the fiber/matrix interface;

[ξ(T), l_{d}] represents a debonding region of the fiber/matrix interface; and

$$[ {l}_{d} , \frac{{l}_{c}}{2} ]$$

represents the bonding region of the fiber/matrix interface.

Preferably, the debonding length equation of the fiber/matrix interface in the step (2) is preferably shown in Formula 2:

$$\frac{{E}_{c} {τ}_{i}^{2} ( T )}{{r}_{f} {V}_{m} {E}_{m} {E}_{f}} {( {l}_{d} - ξ ( T ) )}^{2} + \frac{{E}_{c} {τ}_{i}^{2} ( T )}{ρ {V}_{m} {E}_{m} {E}_{f}} ( {l}_{d} - ξ ( T ) ) - \frac{{τ}_{i} ( T ) σ}{χ {V}_{f} {E}_{f}} ( {l}_{d} - ξ ( T ) ) + \frac{2 {E}_{c} {τ}_{f} ( T ) {τ}_{i} ( T )}{{r}_{f} {V}_{m} {E}_{m} {E}_{f}} ξ ( T ) ( {l}_{d} - ξ ( T ) ) - \frac{{r}_{f} {τ}_{i} ( T ) σ}{2 ρχ {V}_{f} {E}_{f}} + \frac{{E}_{c} {τ}_{f}^{2} ( T )}{{r}_{f} {V}_{m} {E}_{m} {E}_{f}} {ξ}^{2} ( T ) + \frac{{E}_{c} {τ}_{f} ( T ) {τ}_{i} ( T )}{ρ {V}_{m} {E}_{m} {E}_{f}} ξ ( T ) - \frac{{τ}_{f} ( T ) σ}{{V}_{f} {E}_{f}} ξ ( T ) + \frac{{r}_{f} {V}_{m} {E}_{m} {σ}^{2}}{4 {χ}^{2} {V}_{f}^{2} {E}_{f} {E}_{c}} - {ζ}_{d} = 0 ; \qquad Formula 2$$

in Formula 2, l_{d} represents the debonding length of the fiber/matrix interface;

ξ(T) represents the length of the oxidation region at the fiber/matrix interface under a temperature condition;

Eₘ represents an elastic modulus of the matrix;

E_{f} represents an elastic modulus of the fiber;

E_{c} represents an elastic modulus of the woven ceramic-matrix composite; and

ζ_{d} represents a debonding energy at the fiber/matrix interface.

Preferably, the criterion of fracture mechanics in the step (2) is shown in Formula 2-1:

$${ζ}_{d} = \frac{F}{4 π {r}_{f}} \frac{\partial {w}_{f} ( 0 )}{\partial {l}_{d}} - \frac{1}{2} {\int }_{0}^{{l}_{d}} {τ}_{i} ( x ) \frac{\partial v ( x )}{\partial {l}_{d}} dx \qquad Formula 2 \text{-} 1$$

an axial displacement of the fiber is shown in Formula 2-2:

$${w}_{f} ( x ) = \frac{σ}{χ {V}_{f} {E}_{f}} ( {l}_{d} - x ) - \frac{{τ}_{f} ( T )}{{r}_{f} {E}_{f}} ( 2 ξ ( T ) {l}_{d} - {ξ}^{2} ( T ) - {x}^{2} ) - \frac{{τ}_{i} ( T )}{{r}_{f} {E}_{f}} {( {l}_{d} - ξ )}^{2} + \frac{{σ}_{fo}}{{E}_{f}} ( \frac{{l}_{c}}{2} - {l}_{d} ) + \frac{{r}_{f}}{ρ {E}_{f}} [ \frac{{V}_{m}}{χ {V}_{f}} {σ}_{mo} - \frac{2 {τ}_{f} ( T )}{{r}_{f}} ξ ( T ) - \frac{2 {τ}_{i} ( T )}{{r}_{f}} ( {l}_{d} - ξ ( T ) ) ] [ 1 - exp ( - ρ \frac{{l}_{c} / 2 - {l}_{d}}{{r}_{f}} ) ] ; \qquad Formula 2 \text{-} 2$$

an axial displacement of the fiber relative to the matrix is shown in Formula 2-3:

$$v ( x ) = \frac{σ}{χ {V}_{f} {E}_{f}} ( {l}_{d} - x ) - \frac{{E}_{c} {τ}_{f} ( T )}{{r}_{f} {V}_{m} {E}_{m} {E}_{f}} ( 2 ξ ( T ) {l}_{d} - {ξ}^{2} ( T ) - {x}^{2} ) - \frac{{E}_{c} {τ}_{i} ( T )}{{r}_{f} {V}_{m} {E}_{m} {E}_{f}} {( {l}_{d} - ξ ( T ) )}^{2} + \frac{{r}_{f} {E}_{c}}{ρ {V}_{m} {E}_{m} {E}_{f}} [ {σ}_{mo} - 2 \frac{{τ}_{f} ( T )}{{r}_{f}} ξ ( T ) - 2 \frac{{τ}_{i} ( T )}{{r}_{f}} ( {l}_{d} - ξ ( T ) ) ] [ 1 - exp ( - ρ \frac{{l}_{c} / 2 - {l}_{d}}{{r}_{f}} ) ] ; \qquad Formula 2 \text{-} 3$$

in the Formulas 2-1, 2-2 and 2-3,

F represents a load carried by the fiber at a crack plane of the matrix;

$$\frac{\partial {w}_{f} ( 0 )}{\partial {l}_{c}}$$

represents deriving the debonding length of the fiber/matrix interface when x in the axial displacement of the fiber is 0;

$$\frac{\partial v ( x )}{\partial {l}_{c}}$$

represents deriving the debonding length of the fiber/matrix interface when x in the axial displacement of the fiber relative to the matrix is 0;

w_{f}(x) represents the axial displacement of the fiber;

v(x) represents the axial displacement of the fiber relative to the matrix;

l_{c} represents a crack spacing of the matrix;

τ_{f}(T) represents a frictional shear stress of the oxidation region at the fiber/matrix interface under a temperature condition; and

τᵢ(T) represents a frictional shear stress of the slip region at the fiber/matrix interface under a temperature condition.

Preferably, the unloading counter slip length is preferably shown in Formula 3:

$$y = \frac{1}{2} \{ {l}_{d} + ( 1 - \frac{{τ}_{f} ( T )}{{τ}_{i} ( T )} ) ξ - [ \frac{{r}_{f}}{2} ( \frac{{V}_{m} {E}_{m}}{χ {V}_{f} {E}_{c}} \frac{σ}{{τ}_{i} ( T )} - \frac{1}{ρ} ] \sqrt{{( \frac{{r}_{f}}{2 ρ} )}^{2} + \frac{{r}_{f} {V}_{m} {E}_{m} {E}_{f}}{{E}_{c} {τ}_{i}^{2} ( T )} {ζ}_{d}} ] \} ; \qquad Formula 3$$

in Formula 3, y represents an unloading counter slip length.

Preferably, the reloading new slip length equation of the fiber/matrix interface is preferably shown in Formula 4:

$$z = \frac{{τ}_{i} ( T )}{{τ}_{f} ( T )} \{ y - \frac{1}{2} [ {l}_{d} + ( 1 - \frac{{τ}_{f} ( T )}{{τ}_{i} ( T )} ) ξ ( T ) - [ \frac{{r}_{f}}{2} ( \frac{{V}_{m} {E}_{m}}{χ {V}_{f} {E}_{c}} \frac{σ}{{τ}_{i} ( T )} - \frac{1}{ρ} ) - \sqrt{{( \frac{{r}_{f}}{2 ρ} )}^{2} + \frac{{r}_{f} {V}_{m} {E}_{m} {E}_{f}}{{E}_{c} {τ}_{i}^{2} ( T )} {ζ}_{d}} ] ] \} ; \qquad Formula 4$$

in Formula 4, z represents a reloading new slip length of the fiber/matrix interface. Preferably, the unloading stress-strain equation is preferably shown in Formula 5-1:

$${ɛ}_{unloading} ( σ ) = \frac{2 σ {l}_{d}}{χ {V}_{f} {E}_{f} {l}_{c}} + \frac{2 {τ}_{f} ( T )}{{r}_{f} {E}_{f} {l}_{c}} {ξ}^{2} + \frac{4 {τ}_{f} ( T )}{{r}_{f} {E}_{f} {l}_{c}} ξ ( T ) ( {l}_{d} - ξ ( T ) ) + \frac{4 {τ}_{i} ( T )}{{r}_{f} {E}_{f} {l}_{c}} {( y - ξ ( T ) )}^{2} - \frac{2 {τ}_{i} ( T )}{{r}_{f} {E}_{f} {l}_{c}} {( 2 y - ξ ( T ) - {l}_{d} )}^{2} + \frac{2 {σ}_{fo}}{{E}_{f} {l}_{c}} ( \frac{{l}_{c}}{2} - {l}_{d} ) + \frac{2 {r}_{f}}{ρ {E}_{f} {l}_{c}} [ \frac{{V}_{m}}{χ {V}_{f}} {σ}_{mo} + \frac{2 {τ}_{f} ( T )}{{r}_{f}} ξ ( T ) + \frac{2 {τ}_{i}}{{r}_{f}} ( 2 y - ξ ( T ) - {l}_{d} ) ] \times [ 1 - exp ( - ρ \frac{{l}_{c} / 2 - {l}_{d}}{{r}_{f}} ) ] - ( {α}_{c} - {α}_{f} ) Δ T ; \qquad Formula 5 \text{-} 1$$

the reloading stress-strain equation is preferably shown in Formula 5-2:

$${ɛ}_{reloading} ( σ ) = \frac{2 σ }{χ {V}_{f} {E}_{f} {l}_{c}} {l}_{d} - \frac{4 {τ}_{f} ( T )}{{r}_{f} {E}_{f} {l}_{c}} {z}^{2} + \frac{2 {τ}_{f} ( T )}{{r}_{f} {E}_{f} {l}_{c}} {( 2 z - ξ ( T ) )}^{2} - \frac{4 {τ}_{f} ( T )}{{r}_{f} {E}_{f} {l}_{c}} ( 2 z - ξ ( T ) ) ( {l}_{d} - ξ ( T ) ) + \frac{4 {τ}_{i} ( T )}{{r}_{f} {E}_{f} {l}_{c}} {( y - ξ ( T ) )}^{2} - \frac{2 {τ}_{i} ( T )}{{r}_{f} {E}_{f} {l}_{c}} {( 2 y - ξ ( T ) - {l}_{d} )}^{2} \frac{2 {σ}_{fo}}{{E}_{f} {l}_{c}} ( \frac{{l}_{c}}{2} - {l}_{d} ) + \frac{2 {r}_{f}}{ρ {E}_{f} {l}_{c}} [ \frac{{V}_{m}}{χ {V}_{f}} {σ}_{mo} - \frac{2 {τ}_{f} ( T )}{{r}_{f}} ( 2 z - ξ ( T ) ) + \frac{2 {τ}_{i} ( T )}{{r}_{f}} ( 2 y - ξ ( T ) - {l}_{d} ) ] \times [ 1 - exp ( - ρ \frac{{l}_{c} / 2 - {l}_{d}}{{r}_{f}} ) ] - ( {α}_{c} - {α}_{f} ) Δ T ; \qquad Formula 5 \text{-} 2$$

in the formulas 5-1 and 5-2, ε_{unloading}(σ) represents a strain corresponding to an unloading stress; and

ε_{reloading}(σ) represents a strain corresponding to a reloading stress.

Preferably, the fatigue hysteresis dissipated energy equation is preferably shown in Formula 6:

$$U = {\int }_{{σ}_{min}}^{{σ}_{min}} [ {ɛ}_{unloading} ( σ ) - {ɛ}_{reloading} ( σ ) ] d σ ; \qquad Formula 6$$

in Formula 6, U represents a fatigue hysteresis dissipated energy;

σₘₐₓ represents a fatigue peak stress; and

σₘᵢₙ represents a fatigue valley stress.

The present invention includes: based on a shear-lag model, obtaining the axial stress distribution of a fiber, the axial stress distribution of a matrix and the shear stress axial distribution of the fiber/matrix interface, and on this basis, establishing a debonding length equation of the fiber/matrix interface, by using an interface debonding criterion of fracture mechanics and the length of an oxidation region at the fiber/matrix interface; and based on the debonding length equation of the fiber/matrix interface, in combination with an unloading counter slip length equation and a reloading new slip length equation of the fiber/matrix interface established according to a fiber/matrix interface slip mechanism, obtaining an unloading stress-strain equation and a reloading stress-strain equation, and further obtaining a hysteresis dissipated energy equation, to predict the high-temperature fatigue shear stress in the fiber/matrix interface of the woven ceramic-matrix composite under a different cycle number. The foregoing prediction method provided by the present invention fully considers the influence of a temperature and oxidation on the material, so that the predicted high-temperature fatigue shear stress of the composite is more accurate.

### BRIEF DESCRIPTION OF THE DRAWINGS

FIG. 1 is a shear-lag unit cell model of a woven ceramic-matrix composite with a matrix cracking under a stress state provided by the present invention;

FIG. 2 is a relation curve of a woven ceramic-matrix composite between a high-temperature fatigue hysteresis dissipated energy and a shear stress of a fiber/matrix interface provided by the present invention;

FIG. 3 is a test result of a woven ceramic-matrix composite between a high-temperature fatigue hysteresis dissipated energy and a cycle number; and

FIG. 4 is a relation curve of a woven ceramic-matrix composite between a shear stress of a fiber/matrix interface and a cycle number provided by the present invention.

### DETAILED DESCRIPTION

In the method for predicting a high-temperature fatigue shear stress in a fiber/matrix interface of a woven ceramic-matrix composite by a hysteresis dissipated energy provided by the present invention, the involved symbols and their meanings and obtaining methods are summarized in Table 1. In the following specific embodiments, except for special instructions, the meanings and obtaining methods of the symbols in each equation or relational expression are subject to the contents of Table 1.

In the present invention, the high temperature refers to a temperature of 1000° C.

TABLE 1
Parameter specification for prediction method of thermo-mechanical
fatigue hysteresis loop of woven ceramic-matrix composite

| | | Obtaining |
|---|---|---|
| Parameter | Symbol | method |
| Axial stress of fiber | σ_{f}(x) | By calculation |
| Axial stress of matrix | σₘ(x) | By calculation |
| Stress | σ | By measurement |
| Axial stress of fiber in bonding region | σ_{fo} | By calculation |
| of fiber/matrix interface | | |
| Axial stress of matrix in bonding region | σₘₒ | By calculation |
| of fiber/matrix interface | | |
| Volume content of matrix | Vₘ | By measurement |
| Effective volume content coefficient of | χ | By calculation |
| fiber along stress loading direction | | |
| Volume content of fiber | V_{f} | By measurement |
| Frictional shear stress of oxidation | τ_{f} | By measurement |
| region at fiber/matrix interface | | |
| Frictional shear stress of slip region | τᵢ | By measurement |
| at fiber/matrix interface | | |
| Axial shear stress of fiber/matrix | τᵢ(x) | By calculation |
| interface | | |
| Frictional shear stress of oxidation | τ_{f}(T) | By measurement |
| region at fiber/matrix interface under a | | |
| temperature condition | | |
| Frictional shear stress of slip region at | τᵢ(T) | By measurement |
| fiber/matrix interface under a | | |
| temperature condition | | |
| Debonding energy of fiber/matrix | ζ_{d} | By test |
| interface | | |
| Load carried by fiber at crack plane of | F | By calculation |
| matrix | | |
| Length of oxidation region at fiber/ | ξ(T) | By measurement |
| matrix interface under a temperature | | |
| condition | | |
| Debonding length of fiber/matrix | l_{d} | By calculation |
| interface | | |
| Parameter of shear-lag model | ρ | By calculation |
| Radius of fiber | r_{f} | By measurement |
| Elastic modulus of matrix | Eₘ | By measurement |
| Elastic modulus of fiber | E_{f} | By measurement |
| Elastic modulus of woven ceramic- | E_{c} | By measurement |
| matrix composite | | |
| Axial displacement of fiber | W_{f}(x) | By calculation |
| Axial displacement of matrix | wₘ(x) | By calculation |
| Axial displacement of fiber relative to | v(x) | By calculation |
| matrix | | |
| Crack spacing of matrix | l_{c} | By measurement |
| Unloading counter slip length | y | By calculation |
| Reloading new slip length of fiber/ | z | By calculation |
| matrix interface | | |
| Strain corresponding to unloading stress | ε_{unloading}(σ) | By calculation |
| Strain corresponding to reloading stress | ε_{reloading}(σ) | By calculation |
| Fatigue hysteresis dissipated energy | U | By calculation |
| Fatigue peak stress | σₘₐₓ | By measurement |
| Fatigue valley stress | σₘᵢₙ | By measurement |
| Thermal expansion coefficient of | α_{c} | By measurement |
| composite | | |
| Thermal expansion coefficient of fiber | a_{f} | By measurement |

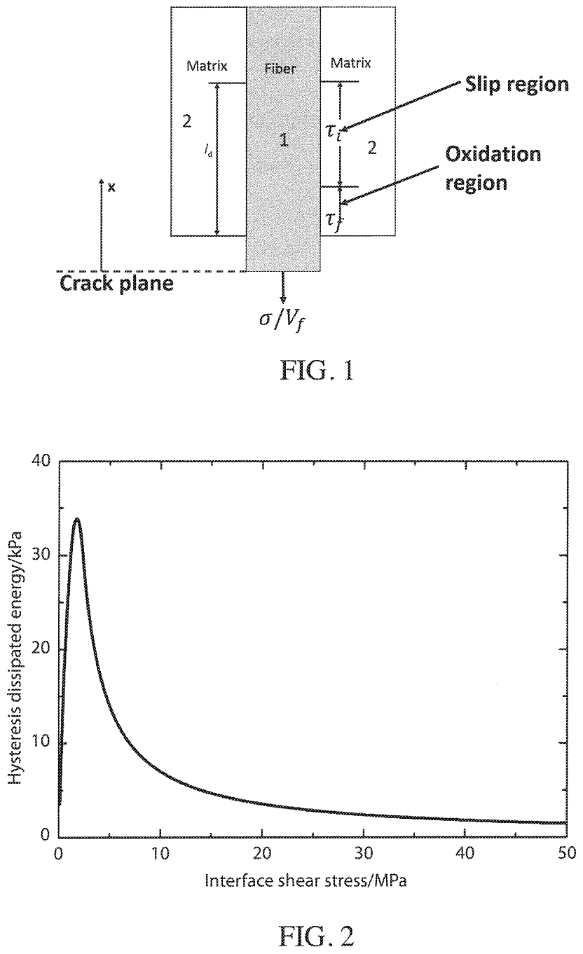

To further clearly describe the method for predicting a high-temperature fatigue shear stress in a fiber/matrix interface of a woven ceramic-matrix composite by a hysteresis dissipated energy of the present invention, the present invention preferably provides a shear-lag unit cell model of the woven ceramic-matrix composite (as shown in FIG. 1), to further explain the meaning of parameters appearing in the present invention.

In FIG. 1, 1 (Fiber) represents a fiber, 2 (Matrix) represents a matrix, x represents an axial direction of the fiber, Crack plane represents a matrix crack plane, Slip region represents a slip region, and Oxidation region represents an oxidation region at a fiber/matrix interface. Under the action of a stress (σ), the fiber and the matrix are cracked to form a debonding region; a debonding length l_{d} of the fiber/matrix interface is divided into a fiber/matrix interface slip region and a fiber/matrix interface oxidation region, where the shear stress of the fiber/matrix interface slip region is τᵢ, and the shear stress of the fiber/matrix interface oxidation region is τ_{f}.

Based on the description of Table 1 and FIG. 1, the method provided by the present invention is described as follows.

The present invention provides a method for predicting a high-temperature fatigue shear stress in a fiber/matrix interface of a woven ceramic-matrix composite by a hysteresis dissipated energy, including the following steps:

(1) based on a shear-lag model, establish an axial stress distribution equation of a fiber, an axial stress distribution equation of a matrix and a shear stress axial distribution equation of the fiber/matrix interface for the woven ceramic-matrix composite with the matrix cracking and with high-temperature debonding and oxidation at the fiber/matrix interface;

(2) according to an interface debonding criterion of fracture mechanics, establish a debonding length equation of the fiber/matrix interface by using the shear stress distribution equation of the fiber/matrix interface obtained in the step (1) and the length of an oxidation region at the fiber/matrix interface;

(3) according to the interface debonding criterion of fracture mechanics, a fiber/matrix interface slip mechanism, and the debonding length equation of the fiber/matrix interface obtained in the step (2), establish an unloading counter slip length equation;

(4) according to the interface debonding criterion of fracture mechanics, the fiber/matrix interface slip mechanism, the debonding length equation of the fiber/matrix interface obtained in the step (2), and the unloading counter slip length equation of the fiber/matrix interface obtained in the step (3), establish a reloading new slip length equation of the fiber/matrix interface;

(5) according to a micro-stress field of a damage region in the woven ceramic-matrix composite, the debonding length equation of the fiber/matrix interface obtained in the step (2), and the unloading counter slip length equation obtained in the step (3), in combination with a global load sharing criterion, establish an unloading stress-strain equation;

according to the micro-stress field of the damage region in the woven ceramic-matrix composite, the debonding length equation of the fiber/matrix interface obtained in the step (2), the unloading counter slip length equation obtained in the step (3) and the reloading new slip length equation of the fiber/matrix interface obtained in the step (4), in combination with the global load sharing criterion, establish a reloading stress-strain equation; and

(6) according to the unloading stress-strain equation and the reloading stress-strain equation obtained in the step (5), establish a fatigue hysteresis dissipated energy equation, to predict the high-temperature fatigue shear stress in the fiber/matrix interface of the woven ceramic-matrix composite under a different cycle number.

Based on the shear-lag model, the present invention establishes the axial stress distribution equation of the fiber, the axial stress distribution equation of the matrix and the shear stress axial distribution equation of the fiber/matrix interface for the woven ceramic-matrix composite with the matrix cracking and with high-temperature debonding and oxidation at the fiber/matrix interface. In the present invention, the shear-lag model is preferably a Budiansky-Hutchinson-Evans shear-lag model.

In the present invention, the axial stress distribution equation of the fiber is preferably shown in Formula 1-1:

$${σ}_{f} ( x ) = \{ \begin{matrix}\frac{σ}{χ {V}_{f}} - \frac{2 {τ}_{f} ( T )}{{r}_{f}} x , x ∈ [ 0 , ξ ( T ) ] \\ \frac{σ}{χ {V}_{f}} - \frac{2 {τ}_{f} ( T )}{{r}_{f}} ξ ( T ) - \frac{2 {τ}_{i} ( T )}{{r}_{f}} ( x - ξ ( T ) ) , x ∈ [ ξ ( T ) , {l}_{d } ] \\ \begin{matrix}{σ}_{fo} + [ \frac{{V}_{m}}{χ {V}_{f}} {σ}_{mo} - 2 \frac{{τ}_{f} ( T )}{{r}_{f}} ξ ( T ) - 2 \frac{{τ}_{i} ( T )}{{r}_{f}} ( {l}_{d} - ξ ( T ) ) ] \\ exp ( - ρ \frac{x - {l}_{d}}{{r}_{f}} ) , x ∈ [ {l}_{d} , \frac{{l}_{c}}{2} ]\end{matrix}\end{matrix} ; \qquad Formula 1 \text{-} 1$$

the axial stress distribution equation of the matrix is preferably shown in Formula 1-2:

$${σ}_{m} ( x ) = \{ \begin{matrix}2 \frac{χ {V}_{f}}{{V}_{m}} \frac{{τ}_{f} ( T )}{{r}_{f}} x , x ∈ [ 0 , ξ ( T ) ] \\ \begin{matrix}2 \frac{χ {V}_{f}}{{V}_{m}} \frac{{τ}_{f} ( T )}{{r}_{f}} ξ ( T ) + 2 \frac{χ {V}_{f}}{{V}_{m}} \frac{{τ}_{i} ( T )}{{r}_{f}} \\ ( x - ξ ( T ) ) , x ∈ [ ξ ( T ) , {l}_{d} ]\end{matrix} \\ \begin{matrix}{σ}_{mo} - [ \begin{matrix}{σ}_{mo} - 2 \frac{χ {V}_{f}}{{V}_{m}} \frac{{τ}_{f} ( T )}{{r}_{f}} ξ ( T ) - \\ 2 \frac{χ {V}_{f}}{{V}_{m}} \frac{{τ}_{i} ( T )}{{r}_{f}} ( {l}_{d} - ξ ( T ) )\end{matrix} ] \\ exp ( - ρ \frac{x - {l}_{d}}{{r}_{f}} ) , x ∈ [ {l}_{d} , \frac{{l}_{c}}{2} ]\end{matrix}\end{matrix} ; \qquad Formula 1 \text{-} 2$$

the shear stress axial distribution equation of the fiber/matrix interface is preferably shown in Formula 1-3:

$${τ}_{i} ( x ) = \{ \begin{matrix}{τ}_{f} ( T ) , x ∈ [ 0 , ξ ( T ) ] \\ {τ}_{i} ( T ) , x ∈ [ ξ ( T ) , {l}_{d} ] \\ \frac{ρ}{2} [ \frac{{V}_{m}}{χ {V}_{f}} {σ}_{mo} - 2 \frac{{τ}_{f} ( T )}{{r}_{f}} ξ ( T ) - \frac{2 {τ}_{i} ( T )}{{r}_{f}} ( {l}_{d} - ξ ( T ) ) ] \\ exp ( - ρ \frac{x - {l}_{d}}{{r}_{f}} ) , x ∈ [ {l}_{d} , \frac{{l}_{c}}{2} ]\end{matrix} ; \qquad Formula 1 \text{-} 3$$

in the formulas 1-1, 1-2 and 1-3, σ_{f}(x) represents an axial stress of the fiber;

σₘ(x) represents an axial stress of the matrix;

σ represents a stress;

σ_{fo} represents an axial stress of the fiber in a bonding region of the fiber/matrix interface;

σₘₒ represents an axial stress of the matrix in the bonding region of the fiber/matrix interface;

Vₘ represents a volume content of the matrix;

χV_{f} represents a volume content of the fiber along a stress loading direction in the woven ceramic-matrix composite;

x represents an axial direction;

τ_{f}(T) represents a frictional shear stress of the oxidation region at the fiber/matrix interface under a temperature condition;

τᵢ(T) represents a frictional shear stress of a slip region at the fiber/matrix interface under a temperature condition;

τᵢ(x) represents an axial stress of the fiber/matrix interface;

ξ(T) represents the length of the oxidation region at the fiber/matrix interface under a temperature condition;

l_{d} represents a debonding length of the fiber/matrix interface;

ρ represents a parameter of the shear-lag model;

r_{f} represents the radius of the fiber;

[0, ξ(T)] represents the oxidation region of the fiber/matrix interface;

[ξ(T), l_{d}] represents a debonding region of the fiber/matrix interface; and

$$[ {l}_{d} , \frac{{l}_{z}}{2} ]$$

represents the bonding region of the fiber/matrix interface.

In the present invention, the axial stress of the fiber in the debonding region of the fiber/matrix interface is preferably obtained by calculation, and the calculation method is preferably:

$${σ}_{fo} = \frac{{E}_{f}}{{E}_{c}} σ ;$$

the axial stress of the matrix in the bonding region of the fiber/matrix interface is preferably obtained by calculation, and the calculation method is preferably:

$${σ}_{mo} = \frac{{E}_{m}}{{E}_{c}} σ .$$

In the present invention, the frictional shear stress of the oxidation region at the fiber/matrix interface under a temperature condition and the frictional shear stress of the slip region at the fiber/matrix interface under a temperature condition are preferably obtained by measurement, and are further preferably obtained by hysteresis loop measurement. The present invention has no special requirement on the measurement method, and a method well known to those skilled in the art can be used.

In the present invention, when the matrix of the woven ceramic-matrix composite is cracked, the axial fiber/matrix interface of the fiber and the matrix may be sequentially divided into: an oxidation region, a debonding region and a bonding region, where the oxidation region is from a crack plane of the matrix to the finish end of the length of the oxidation region; the debonding region starts from the finish end of the length of the oxidation region to the finish end of the debonding length; the bonding region is from the finish end of the debonding length to one-half of the crack spacing of the matrix. In the present invention, the length of the oxidation region is preferably expressed by the length of the oxidation region at the fiber/matrix interface under a temperature condition; the influence of the temperature on oxidation can be incorporated into a stress distribution process, so that the stress distribution is more in line with the actual situation to improve the stress distribution accuracy.

In the present invention, the formulas 1-1, 1-2 and 1-3 include the distribution of the three regions: the oxidation region of the fiber/matrix interface, the debonding region of the fiber/matrix interface, and the bonding region of the fiber/matrix interface. Thus, the distribution of the axial stress of the fiber, the axial stress of the matrix and the axial shear stress of the fiber/matrix interface is more microscopic and accurate to serve as an input parameter for the analysis of the unloading and reloading stress-strain relations.

When the stress distribution equations are obtained, the present invention establishes the debonding length equation of the fiber/matrix interface by the shear stress distribution equation of the fiber/matrix interface and the length of the oxidation region at the fiber/matrix interface, according to the interface debonding criterion of fracture mechanics

In the present invention, the debonding length equation of the fiber/matrix interface is preferably shown in Formula 2:

$$\frac{{E}_{c} {τ}_{i}^{2} ( T )}{{r}_{f} {V}_{m} {E}_{m} {E}_{f}} {( {l}_{d} - ξ ( T ) )}^{2} + \frac{{E}_{c} {τ}_{i}^{2} ( T )}{ρ {V}_{m} {E}_{m} {E}_{f}} ( {l}_{d} - ξ ( T ) ) - \frac{{τ}_{i} ( T ) σ}{χ {V}_{f} {E}_{f}} ( {l}_{d} - ξ ( T ) ) + \frac{2 {E}_{c} {τ}_{f} ( T ) {τ}_{i} ( T )}{{r}_{f} {V}_{m} {E}_{m} {E}_{f}} ξ ( T ) ( {l}_{d} - ξ ( T ) ) - \frac{{r}_{f} {τ}_{i} ( T ) σ}{2 ρχ {V}_{f} {E}_{f}} + \frac{{E}_{c} {τ}_{f}^{2} ( T )}{{r}_{f} {V}_{m} {E}_{m} {E}_{f}} {ξ}^{2} ( T ) + \frac{{E}_{c} {τ}_{f} ( T ) {τ}_{i} ( T )}{ρ {V}_{m} {E}_{m} {E}_{f}} ξ - \frac{{τ}_{f} ( T ) σ}{{V}_{f} {E}_{f}} ξ ( T ) + \frac{{r}_{f} {V}_{m} {E}_{m} {σ}^{2}}{4 {χ}^{2} {V}_{f}^{2} {E}_{f} {E}_{c}} - {ζ}_{d} = 0 ; \qquad Formula 2$$

in Formula 2, l_{d} represents the debonding length of the fiber/matrix interface;

ξ(T) represents the length of the oxidation region at the fiber/matrix interface under a temperature condition;

Eₘ represents an elastic modulus of the matrix;

E_{f} represents an elastic modulus of the fiber;

E_{c} represents an elastic modulus of the woven ceramic-matrix composite; and

ζ_{d} represents a debonding energy at the fiber/matrix interface.

In the present invention, the debonding length equation of the fiber/matrix interface is preferably a relational expression of the debonding length of the fiber/matrix interface, the length of the oxidation region at the fiber/matrix interface, the frictional shear stress of the oxidation region at the fiber/matrix interface, the frictional shear stress of the slip region at the fiber/matrix interface, and the stress, which can be used to determine the debonding length of the fiber/matrix interface under a different load and a different cycle number.

In the present invention, the interface debonding criterion of fracture mechanics used to construct the debonding length equation of the fiber/matrix interface is preferably shown in Formula 2-1:

$${ζ}_{d} = \frac{F}{4 π {r}_{f}} \frac{\partial {w}_{f} ( 0 )}{\partial {l}_{d}} - \frac{1}{2} {\int }_{0}^{{l}_{d}} {τ}_{i} ( x ) \frac{\partial v ( x )}{\partial {l}_{d}} dx \qquad Formula 2 \text{-} 1$$

In Formula 2-1,

F represents a load carried by the fiber at the crack plane of the matrix;

$$\frac{\partial {w}_{i} ( 0 )}{\partial {l}_{c}}$$

represents deriving the debonding length of the fiber/matrix interface when x in an axial displacement of the fiber is 0; and

$$\frac{\partial v ( x )}{\partial {l}_{c}}$$

represents deriving the debonding length of the fiber/matrix interface when x in an axial displacement of the fiber relative to the matrix is 0.

In the present invention, the axial displacement of the fiber is preferably shown in Formula 2-2;

$${w}_{f} ( x ) = \frac{σ}{χ {V}_{f} {E}_{f}} ( {l}_{d} - x ) - \frac{{τ}_{f} ( T )}{{r}_{f} {E}_{f}} ( 2 ξ ( T ) {l}_{d} - {ξ}^{2} ( T ) - {x}^{2} ) - \frac{{τ}_{i} ( T )}{{r}_{f} {E}_{f}} {( {l}_{d} - ξ ( T ) )}^{2} + \frac{{σ}_{fo}}{{E}_{f}} ( \frac{{l}_{c}}{2} - {l}_{d} ) + \frac{{r}_{f}}{ρ {E}_{f}} [ \frac{{V}_{m}}{χ {V}_{f}} {σ}_{mo} - \frac{2 τ ( T )}{{r}_{f}} ξ ( T ) - \frac{2 {τ}_{i} ( T )}{{r}_{f}} ( {l}_{d} - ξ ( T ) ) ] [ 1 - exp ( - ρ \frac{{l}_{c} / 2 - {l}_{d}}{{r}_{f}} ) ] ; \qquad Formula 2 \text{-} 2$$

w_{f}(x) represents the axial displacement of the fiber;

l_{c} represents a crack spacing of the matrix;

τ_{f}(T) represents a frictional shear stress of the oxidation region at the fiber/matrix interface under a temperature condition; and

τᵢ(T) represents a frictional shear stress of the slip region at the fiber/matrix interface under a temperature condition.

In the present invention, the axial displacement of the fiber relative to the matrix is preferably shown in Formula 2-3:

$$v ( x ) = \frac{σ}{χ {V}_{f} {E}_{f}} ( {l}_{d} - x ) - \frac{{E}_{c} {τ}_{f} ( T )}{{r}_{f} {V}_{m} {E}_{m} {E}_{f}} ( 2 ξ ( T ) {l}_{d} - {ξ}^{2} ( T ) - {x}^{2} ) - \frac{{E}_{c} {τ}_{i} ( T )}{{r}_{f} {V}_{m} {E}_{m} {E}_{f}} {( {l}_{d} - ξ ( T ) )}^{2} + \frac{{r}_{f} {E}_{c}}{ρ {V}_{m} {E}_{m} {E}_{f}} [ {σ}_{mo} - 2 \frac{{τ}_{f} ( T )}{{r}_{f}} ξ ( T ) - 2 \frac{{τ}_{i} ( T )}{{r}_{f}} ( {l}_{d} - ξ ( T ) ) ] [ 1 - exp ( - ρ \frac{{l}_{c} / 2 - {l}_{d}}{{r}_{i}} ) ] ; \qquad Formula 2 \text{-} 3$$

in Formula 2-3, v(x) represents the axial displacement of the fiber relative to the matrix.

In the present invention, when the damage region in the woven ceramic-matrix composite is under the action of a stress, both the fiber and the matrix will be moved, where the moving distance of the fiber is expressed by the axial displacement of the fiber (w_{f}(x)), and the moving distance of the matrix is expressed by the axial displacement of the matrix (wₘ(x)); the axial displacement of the matrix is preferably shown in Formula 2-4:

$${w}_{m} ( x ) = \frac{χ {V}_{f} {τ}_{f} ( T )}{{r}_{f} {V}_{m} {E}_{m}} ( 2 ξ ( T ) {l}_{d} - {ξ}^{2} ( T ) - {x}^{2} ) + \frac{χ {V}_{f} {τ}_{i} ( T )}{{r}_{i} {V}_{m} {E}_{m}} {( {l}_{d} - ξ ( T ) )}^{2} + \frac{{σ}_{mo}}{{E}_{m}} ( \frac{{l}_{c}}{2} - {l}_{d} ) - \frac{{r}_{f}}{ρ {E}_{m}} [ {σ}_{mo} - 2 \frac{χ {V}_{f} {τ}_{f} ( T )}{{r}_{f} {V}_{m}} ξ ( T ) - 2 \frac{χ {V}_{f} {τ}_{i} ( T )}{{r}_{i} {V}_{m}} ( {l}_{d} - ξ ( T ) ) ] [ 1 - exp ( - ρ \frac{{l}_{c} / 2 - {l}_{d}}{{r}_{f}} ) ] . \qquad Formula 2 \text{-} 4$$

In the present invention, the absolute difference of the axial displacement of the fiber and the axial displacement of the matrix is the axial displacement of the fiber relative to the matrix. In the present invention, the expression of the axial displacement of the fiber relative to the matrix shown in Formula 2-3 is preferably obtained by the formulas 2-2 and 2-4. In the present invention, the debonding length equation of the fiber/matrix interface shown in Formula 2 is preferably obtained by combing the formulas 2-2, 2-3 and 2-1. It can be seen from the debonding length equation of the fiber/matrix interface shown in Formula 2, the debonding length of the fiber/matrix interface of the present invention is an expression including the parameters, such as the length of the oxidation region at the fiber/matrix interface, the frictional shear stress of the oxidation region at the fiber/matrix interface, the frictional shear stress of the slip region at the fiber/matrix interface, and the crack spacing of the matrix. These parameters are affected by the factors of temperature and oxidation. Therefore, the debonding length of the fiber/matrix interface is a parameter that incorporates the factors of temperature and oxidation. Then, based on the parameter of the debonding length of the fiber/matrix interface, the subsequent hysteresis dissipated energy equation is constructed to make the theoretical value of the hysteresis dissipated energy closer to the actual situation, which is beneficial to improve the accuracy of the predicted value of the high-temperature fatigue shear stress in the fiber/matrix interface of the woven ceramic-matrix composite.

When the debonding length equation of the fiber/matrix interface is obtained, the present invention establishes the unloading counter slip length equation according to the interface debonding criterion of fracture mechanics, the fiber/matrix interface slip mechanism, and the debonding length equation of the fiber/matrix interface. In the present invention, the unloading counter slip length equation is preferably shown in Formula 3:

$$y = \frac{1}{2} \{ {l}_{d} + ( 1 - \frac{{τ}_{f} ( T )}{{τ}_{i} ( T )} ) ξ ( T ) - [ \frac{{r}_{f}}{2} ( \frac{{V}_{m} {E}_{m}}{χ {V}_{f} {E}_{c}} \frac{σ}{{τ}_{i} ( T )} - \frac{1}{ρ} ) - \sqrt{{( \frac{{r}_{f}}{2 ρ} )}^{2} + \frac{{r}_{f} {V}_{m} {E}_{m} {E}_{f}}{{E}_{c} {τ}_{i}^{2} ( T )} {ζ}_{d}} ] \} ; \qquad Formula 3$$

in Formula 3, y represents the unloading counter slip length equation.

In the present invention, the unloading counter slip length refers to a counter slip distance of the fiber/matrix interface during a stress unloading process. In the present invention, the unloading counter slip length equation is preferably a relational expression of the unloading counter slip length, the debonding length of the fiber/matrix interface, the frictional shear stress of the oxidation region at the fiber/matrix interface, the frictional shear stress of the slip region at the fiber/matrix interface, the length of the oxidation region at the fiber/matrix interface, and the stress; the relational expression can be used to express the unloading counter slip length of the fiber/matrix interface.

When the unloading counter slip length equation is obtained, the present invention establishes the reloading new slip length equation of the fiber/matrix interface according to the interface debonding criterion of fracture mechanics, the fiber/matrix interface slip mechanism, the debonding length equation of the fiber/matrix interface, and the unloading counter slip length equation of the fiber/matrix interface. In the present invention, the reloading new slip length equation of the fiber/matrix interface is preferably shown in Formula 4:

$$z = \frac{{τ}_{i} ( T )}{{τ}_{f} ( T )} \{ y - \frac{1}{2} [ {l}_{d} + ( 1 - \frac{{τ}_{f} ( T )}{{τ}_{i} ( T )} ) ξ ( T ) - [ \frac{{r}_{f}}{2} ( \frac{{V}_{m} {E}_{m}}{χ {V}_{f} {E}_{c}} \frac{σ}{{τ}_{i} ( T )} - \frac{1}{ρ} ) - \sqrt{{( \frac{{r}_{f}}{2 ρ} )}^{2} + \frac{{r}_{f} {V}_{m} {E}_{m} {E}_{f}}{{E}_{c} {τ}_{i}^{2} ( T )} {ζ}_{d}} ] ] \} ; \qquad Formula 4$$

In Formula 4, z represents a reloading new slip length of the fiber/matrix interface.

In the present invention, the reloading new slip length equation of the fiber/matrix interface is preferably a relational expression of the reloading new slip length of the fiber/matrix interface, the unloading counter slip length, the frictional shear stress of the oxidation region at the fiber/matrix interface, the frictional shear stress of the slip region at the fiber/matrix interface, the debonding length, the length of the oxidation region under a temperature condition, and the stress, which provides a basis for the establishment of the stress-strain equations.

When the reloading new slip length equation of the fiber/matrix interface is obtained, the present invention establishes the unloading stress-strain equation according to the micro-stress field of the damage region in the woven ceramic-matrix composite, the debonding length equation of the fiber/matrix interface, and the unloading counter slip length equation, in combination with the global load sharing criterion.

The present invention establishes the reloading stress-strain equation according to the micro-stress field of the damage region in the woven ceramic-matrix composite, the debonding length equation of the fiber/matrix interface, the unloading counter slip length equation, and the reloading new slip length equation of the fiber/matrix interface, in combination with the global load sharing criterion.

In the present invention, the unloading stress-strain equation is shown in Formula 5-1:

$${ɛ}_{unloading} ( σ ) = \frac{2 σ {l}_{d}}{χ {V}_{f} {E}_{f} {l}_{c}} + \frac{2 {τ}_{f} ( T )}{{r}_{f} {E}_{f} {l}_{c}} {ξ}^{2} ( T ) + \frac{4 {τ}_{f} ( T )}{{r}_{f} {E}_{f} {l}_{c}} ξ ( T ) ( {l}_{d} - ξ ( T ) ) + \frac{4 {τ}_{i} ( T )}{{r}_{f} {E}_{f} {l}_{c}} {( y - ξ ( T ) )}^{2} - \frac{2 {τ}_{i} ( T )}{{r}_{f} {E}_{f} {l}_{c}} {( 2 y - ξ ( T ) - {l}_{d} )}^{2} + \frac{2 {σ}_{fo}}{{E}_{f} {l}_{c}} ( \frac{{l}_{c}}{2} - {l}_{d} ) + \frac{2 {r}_{f}}{ρ {E}_{f} {l}_{c}} [ \frac{{V}_{m}}{χ {V}_{f}} {σ}_{mo} + \frac{2 {τ}_{f} ( T )}{{r}_{f}} ξ ( T ) + \frac{2 {τ}_{i} ( T )}{{r}_{f}} ( 2 y - ξ ( T ) - {l}_{d} ) ] \times [ 1 - exp ( - ρ \frac{{l}_{c} / 2 - {l}_{d}}{{r}_{f}} ) ] - ( {α}_{c} - {α}_{f} ) Δ T ; \qquad Formula 5 \text{-} 1$$

the reloading stress-strain equation is preferably shown in Formula 5-2:

$${ɛ}_{reloading} ( σ ) = \frac{2 σ}{χ {V}_{f} {E}_{f} {l}_{c}} {l}_{d} - \frac{4 {τ}_{f} ( T )}{{r}_{f} {E}_{f} {l}_{c}} {z}^{2} + \frac{2 {τ}_{f} ( T )}{{r}_{f} {E}_{f} {l}_{c}} {( 2 z - ξ ( T ) )}^{2} - \frac{4 {τ}_{f} ( T )}{{r}_{f} {E}_{f} {l}_{c}} ( 2 z - ξ ( T ) ) ( {l}_{d} - ξ ( T ) ) + \frac{4 {τ}_{i} ( T )}{{r}_{f} {E}_{f} {l}_{c}} {( y - ξ ( T ) )}^{2} - \frac{2 {τ}_{i} ( T )}{{r}_{f} {E}_{f} {l}_{c}} {( 2 y - ξ ( T ) - {l}_{d} )}^{2} + \frac{2 {σ}_{fo}}{{E}_{f} {l}_{c}} ( \frac{{l}_{c}}{2} - {l}_{d} ) + \frac{2 {r}_{f}}{ρ {E}_{f} {l}_{c}} [ \frac{{V}_{m}}{χ {V}_{f}} {σ}_{mo} - \frac{2 {τ}_{f} ( T )}{{r}_{f}} ( 2 z - ξ ( T ) ) + \frac{2 {τ}_{i} ( T )}{{r}_{f}} ( 2 y - ξ ( T ) - {l}_{d} ) ] \times [ 1 - exp ( - ρ \frac{{l}_{c} / 2 - {l}_{d}}{{r}_{f}} ) ] - ( {α}_{c} - {α}_{f} ) Δ T ; \qquad Formula 5 \text{-} 2$$

in the formulas 5-1 and 5-2, ε_{unloading}(σ) represents a strain corresponding to an unloading stress; and

ε_{reloading}(σ) represents a strain corresponding to a reloading stress.

In the present invention, the unloading stress-strain equation and the reloading stress-strain equation are expressions of the stress, the crack spacing of the matrix, the debonding length of the fiber/matrix interface, the frictional shear stress of the oxidation region at the fiber/matrix interface, the frictional shear stress of the slip region at the fiber/matrix interface, the length of the oxidation region at the fiber/matrix interface, the axial stress of the fiber in the bonding region of the fiber/matrix interface, the axial stress of the matrix in the bonding region of the fiber/matrix interface, the unloading counter slip length, and the reloading new slip length of the fiber/matrix interface. In combination with the expressions of the debonding length of the fiber/matrix interface, the unloading counter slip length and the reloading new slip length of the fiber/matrix in the foregoing technical solutions, the stress-strain equations are finally obtained, which are expressed by the length of the oxidation region at the fiber/matrix interface, the frictional shear stress of the oxidation region at the fiber/matrix interface, the frictional shear stress of the slip region at the fiber/matrix interface, the stress, the crack spacing of the matrix, the axial stress of the fiber in the bonding region of the fiber/matrix interface, and the axial stress of the matrix in the bonding region of the fiber/matrix interface, providing a basis for the subsequent establishment of the fatigue hysteresis dissipated energy equation.

When the stress-strain equations are obtained, the present invention establishes the fatigue hysteresis dissipated energy equation according to the unloading stress-strain equation and the reloading stress-strain equation, to predict the high-temperature fatigue shear stress in the fiber/matrix interface of the woven ceramic-matrix composite under a different cycle number. In the present invention, the fatigue hysteresis dissipated energy equation is preferably shown in Formula 6:

$$U = {\int }_{{σ}_{min}}^{{σ}_{max}} [ {ɛ}_{unloading} ( σ ) - {ɛ}_{reloading} ( σ ) ] d σ ; \qquad Formula 6$$

in Formula 6, U represents a fatigue hysteresis dissipated energy;

σₘₐₓ represents a fatigue peak stress; and

σₘᵢₙ min represents a fatigue valley stress.

The present invention utilizes the unloading stress-strain and the reloading stress-strain to obtain the expression of the fatigue hysteresis dissipated energy equation, including the length of the oxidation region at the fiber/matrix interface, the frictional shear stress of the oxidation region at the fiber/matrix interface, the frictional shear stress of the slip region at the fiber/matrix interface, the stress, the crack spacing of the matrix, the axial stress of the fiber in the bonding region of the fiber/matrix interface, and the axial stress of the matrix in the bonding region of the fiber/matrix interface, which can be combined with the basic performance parameters of the woven ceramic-matrix composite to predict the high-temperature fatigue shear stress in the fiber/matrix interface of the woven ceramic-matrix composite under a different cycle number.

In the present invention, the prediction method is preferably: obtain an analogue relation curve between the fatigue hysteresis dissipated energy and the shear stress of the fiber/matrix interface by the fatigue dissipated energy equation of the woven ceramic-matrix composite; and test the fatigue hysteresis dissipated energy of the woven ceramic-matrix composite under a different cycle number, and when the fatigue hysteresis dissipated energy is equal to the fatigue hysteresis dissipated energy in the analogue curve, obtain the shear stress of the fiber/matrix interface under a different cycle number.

To further describe the present invention, the following describes the method for predicting a high-temperature fatigue shear stress of a fiber/matrix interface in a woven ceramic-matrix composite provided by the present invention below in detail with reference to the accompanying drawings and embodiments, which may not be interpreted as a limitation to the protection scope of the present invention.

### Embodiment 1

A two-dimensional silicon carbide/silicon carbide (2D SiC/SiC) woven ceramic-matrix composite was used as a test sample; the test sample was oxidized and fatigued under a high-temperature environment (1000° C.).

Material parameters: E_{f}=150 GPa, Eₘ=60 GPa, V_{f}=21.5%, r_{f}=7.5 μm, α_{f}=4.6×10⁻⁶/° C., ζ_{d}=3.1 J/m²; χ=0.5, αₘ=4.38×10⁻⁶/° C., ΔT=−400° C., Vₘ=78.5%, σₘₐₓ=80 MPa, and σₘᵢₙ=8 MPa.

The fatigue hysteresis dissipated energy of the woven ceramic-matrix composite could be obtained by substituting the foregoing parameters into the various established equations. A relation curve between the fatigue hysteresis dissipated energy and the shear stress of the fiber/matrix interface was drawn, as shown in FIG. 2.

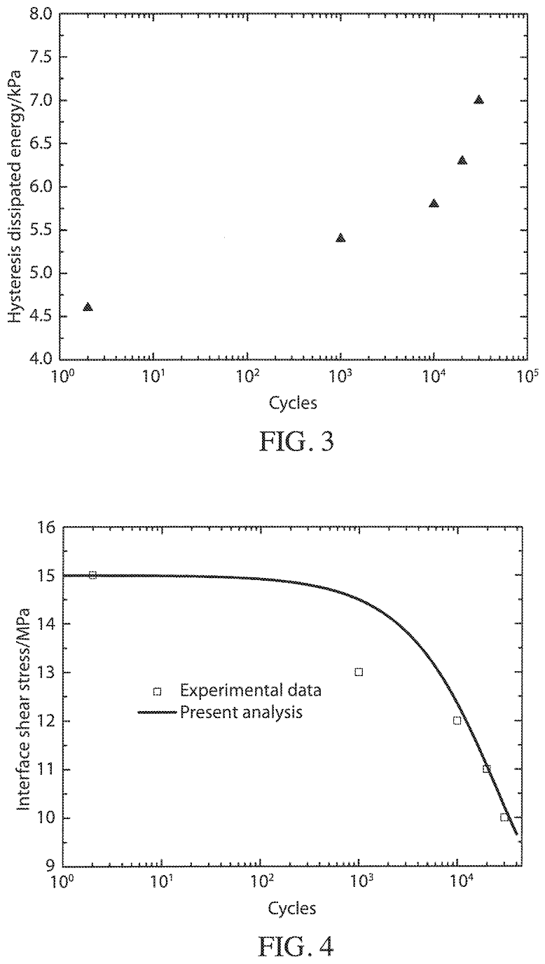

The fatigue hysteresis dissipated energy of the woven ceramic-matrix composite under a different cycle number was tested, with a test result shown in FIG. 3. The test result was compared with a predicted value of the fatigue hysteresis dissipated energy obtained according to the fatigue hysteresis dissipated energy equation. When the two were equal, the stress under the cycle number corresponding to the fatigue hysteresis dissipated energy was the shear stress in the fiber/matrix interface of the woven ceramic-matrix composite, thus obtaining a relation curve of the woven ceramic-matrix composite between the shear stress of the fiber/matrix interface and the cycle number, as shown in FIG. 4. It can be seen from FIG. 4 that the predicted value and the test value have a high degree of coincidence, indicating that the prediction result obtained by the present invention is highly accurate.

Although the aforementioned embodiments illustrate the present invention in detail, they are only parts of the embodiments of the present invention, rather than all of the embodiments. Other embodiments can be obtained by people according to these embodiments without the premise of inventiveness, and all of the embodiments fall within the claimed scope of the present invention.

What is claimed is:

1. A method for predicting a high-temperature fatigue shear stress in a fiber/matrix interface of a woven ceramic-matrix composite by a hysteresis dissipated energy, comprising the following steps:
(1) based on a shear-lag model, establishing an axial stress distribution equation of a fiber, an axial stress distribution equation of a matrix and a shear stress axial distribution equation of the fiber/matrix interface for the woven ceramic-matrix composite with the matrix cracking and with high-temperature debonding and oxidation at the fiber/matrix interface;
(2) according to an interface debonding criterion of fracture mechanics, establishing a debonding length equation of the fiber/matrix interface by using the shear stress distribution equation of the fiber/matrix interface obtained in the step (1) and the length of an oxidation region at the fiber/matrix interface;
(3) according to the interface debonding criterion of fracture mechanics, a fiber/matrix interface slip mechanism, and the debonding length equation of the fiber/matrix interface obtained in the step (2), establishing an unloading counter slip length equation;
(4) according to the interface debonding criterion of fracture mechanics, the fiber/matrix interface slip mechanism, the debonding length equation of the fiber/matrix interface obtained in the step (2), and the unloading counter slip length equation of the fiber/matrix interface obtained in the step (3), establishing a reloading new slip length equation of the fiber/matrix interface;
(5) according to a micro-stress field of a damage region in the woven ceramic-matrix composite, the debonding length equation of the fiber/matrix interface obtained in the step (2), and the unloading counter slip length equation obtained in the step (3), in combination with a global load sharing criterion, establishing an unloading stress-strain equation;
according to the micro-stress field of the damage region in the woven ceramic-matrix composite, the debonding length equation of the fiber/matrix interface obtained in the step (2), the unloading counter slip length equation obtained in the step (3), and the reloading new slip length equation of the fiber/matrix interface obtained in the step (4), in combination with the global load sharing criterion, establishing a reloading stress-strain equation; and
(6) according to the unloading stress-strain equation and the reloading stress-strain equation obtained in the step (5), establishing a fatigue hysteresis dissipated energy equation, to predict the high-temperature fatigue shear stress in the fiber/matrix interface of the woven ceramic-matrix composite under a different cycle number.

2. The method according to claim 1, wherein the axial stress distribution equation of the fiber in the step (1) is preferably shown in Formula 1-1:
$${σ}_{f} ( x ) = \{ \begin{matrix}\frac{σ}{χ {V}_{f}} - \frac{2 {τ}_{f} ( T )}{{r}_{f}} x , x ∈ [ 0 , ξ ( T ) ] \\ \frac{σ}{χ {V}_{f}} - \frac{2 {τ}_{f} ( T )}{{r}_{f}} ξ ( T ) - \frac{2 {τ}_{i} ( T )}{{r}_{f}} ( x - ξ ( T ) ) , x ∈ [ ξ ( T ) , {l}_{d} ] \\ \begin{matrix}{σ}_{fo} + [ \frac{{V}_{m}}{χ {V}_{f}} {σ}_{mo} - 2 \frac{{τ}_{f} ( T )}{{r}_{f}} ξ ( T ) - 2 \frac{{τ}_{i} ( T )}{{r}_{f}} ( {l}_{d} - ξ ( T ) ) ] \\ exp ( - ρ \frac{x - {l}_{d}}{{r}_{f}} ) , x ∈ [ {l}_{d} , \frac{{l}_{c}}{2} ]\end{matrix}\end{matrix} ; \qquad Formula 1 \text{-} 1$$
the axial stress distribution equation of the matrix is preferably shown in Formula 1-2:
$${σ}_{m} ( x ) = \{ \begin{matrix}2 \frac{χ {V}_{f}}{{V}_{m}} \frac{{τ}_{f} ( T )}{{r}_{f}} x , x ∈ [ 0 , ξ ( T ) ] \\ \begin{matrix}2 \frac{χ {V}_{f}}{{V}_{m}} \frac{{τ}_{f} ( T )}{{r}_{f}} ξ ( T ) + 2 \frac{χ {V}_{f}}{{V}_{m}} \frac{{τ}_{i} ( T )}{{r}_{f}} \\ ( x - ξ ( T ) ) , x ∈ [ ξ ( T ) , {l}_{d} ]\end{matrix} \\ \begin{matrix}{σ}_{mo} - [ \begin{matrix}{σ}_{mo} - 2 \frac{χ {V}_{f}}{{V}_{m}} \frac{{τ}_{f} ( T )}{{r}_{f}} ξ ( T ) - \\ 2 \frac{χ {V}_{f}}{{V}_{m}} \frac{{τ}_{i} ( T )}{{r}_{f}} ( {l}_{d} - ξ ( T ) )\end{matrix} ] \\ exp ( - ρ \frac{x - {l}_{d}}{{r}_{f}} ) , x ∈ [ {l}_{d} , \frac{{l}_{c}}{2} ]\end{matrix}\end{matrix} ; \qquad Formula 1 \text{-} 2$$
the shear stress axial distribution equation of the fiber/matrix interface is preferably shown in Formula 1-3:
$${τ}_{i} ( x ) = \{ \begin{matrix}{τ}_{f} ( T ) , x ∈ [ 0 , ξ ( T ) ] \\ {τ}_{i} ( T ) , x ∈ [ ξ ( T ) , {l}_{d} ] \\ \frac{ρ}{2} [ \begin{matrix}\frac{{V}_{m}}{χ {V}_{f}} {σ}_{mo} - 2 \frac{{τ}_{f} ( T )}{{r}_{f}} ξ ( T ) - \\ \frac{2 {τ}_{i} ( T )}{{r}_{f}} ( {l}_{d} - ξ ( T ) )\end{matrix} ] \\ exp ( - ρ \frac{x - {l}_{d}}{{r}_{f}} ) , x ∈ [ {l}_{d} , \frac{{l}_{c}}{2} ]\end{matrix} ; \qquad Formula 1 \text{-} 3$$
in the formulas 1-1, 1-2 and 1-3, σ_{f}(x) represents an axial stress of the fiber;
σₘ(x) represents an axial stress of the matrix;
σ represents a stress;
σ_{fo} represents an axial stress of the fiber in a bonding region of the fiber/matrix interface;
σₘₒ represents an axial stress of the matrix in the bonding region of the fiber/matrix interface;
Vₘ represents a volume content of the matrix;
χV_{f} represents a volume content of the fiber along a stress loading direction in the woven ceramic-matrix composite;
x represents an axial direction;
τ_{f}(T) represents a frictional shear stress of the oxidation region at the fiber/matrix interface under a temperature condition;
τᵢ(T) represents a frictional shear stress of a slip region at the fiber/matrix interface under a temperature condition;
τᵢ(x) represents an axial stress of the fiber/matrix interface;
ξ(T) represents the length of the oxidation region at the fiber/matrix interface under a temperature condition;
l_{d} represents a debonding length of the fiber/matrix interface;
ρ represents a parameter of the shear-lag model;
r_{f} represents the radius of the fiber;
[0, ξ(T)] represents the oxidation region of the fiber/matrix interface;
[ξ(T), l_{d}] represents a debonding region of the fiber/matrix interface; and
$$[ {l}_{d} , \frac{{l}_{c}}{2} ]$$
represents the bonding region of the fiber/matrix interface.

3. The method according to claim 1, wherein the debonding length equation of the fiber/matrix interface in the step (2) is preferably shown in Formula 2:
$$\frac{{E}_{c} {τ}_{i}^{2} ( T )}{{r}_{f} {V}_{m} {E}_{m} {E}_{f}} {( {l}_{d} - ξ ( T ) )}^{2} + \frac{{E}_{c} {τ}_{i}^{2} ( T )}{ρ {V}_{m} {E}_{m} {E}_{f}} ( {l}_{d} - ξ ( T ) ) - \frac{{τ}_{i} ( T ) σ}{χ {V}_{f} {E}_{f}} ( {l}_{d} - ξ ( T ) ) + \frac{2 {E}_{c} {τ}_{f} ( T ) {τ}_{i} ( T )}{{r}_{f} {V}_{m} {E}_{m} {E}_{f}} ξ ( T ) ( {l}_{d} - ξ ( T ) ) - \frac{{r}_{f} {τ}_{i} ( T ) σ}{2 ρ χ {V}_{f} {E}_{f}} + \frac{{E}_{c} {τ}_{f}^{2} ( T )}{{r}_{f} {V}_{m} {E}_{m} {E}_{f}} {ξ}^{2} ( T ) + \frac{{E}_{c} {τ}_{f} ( T ) {τ}_{i} ( T )}{ρ {V}_{m} {E}_{m} {E}_{f}} ξ ( T ) - \frac{{τ}_{f} ( T ) σ}{{V}_{f} {E}_{f}} ξ ( T ) + \frac{{r}_{f} {V}_{m} {E}_{m} {σ}^{2}}{4 {χ}^{2} {V}_{f}^{2} {E}_{f} {E}_{c}} - {ζ}_{d} = 0 ; \qquad Formula 2$$
in Formula 2, l_{d} represents the debonding length of the fiber/matrix interface;
ξ(T) represents the length of the oxidation region at the fiber/matrix interface under a temperature condition;
Eₘ represents an elastic modulus of the matrix;
E_{f} represents an elastic modulus of the fiber;
E_{c} represents an elastic modulus of the woven ceramic-matrix composite; and
ξ_{d} represents a debonding energy at the fiber/matrix interface.

4. The method according to claim 2, wherein the debonding length equation of the fiber/matrix interface in the step (2) is preferably shown in Formula 2:
$$\frac{{E}_{c} {τ}_{i}^{2} ( T )}{{r}_{f} {V}_{m} {E}_{m} {E}_{f}} {( {l}_{d} - ξ ( T ) )}^{2} + \frac{{E}_{c} {τ}_{i}^{2} ( T )}{ρ {V}_{m} {E}_{m} {E}_{f}} ( {l}_{d} - ξ ( T ) ) - \frac{{τ}_{i} ( T ) σ}{χ {V}_{f} {E}_{f}} ( {l}_{d} - ξ ( T ) ) + \frac{2 {E}_{c} {τ}_{f} ( T ) {τ}_{i} ( T )}{{r}_{f} {V}_{m} {E}_{m} {E}_{f}} ξ ( T ) ( {l}_{d} - ξ ( T ) ) - \frac{{r}_{f} {τ}_{i} ( T ) σ}{2 ρ χ {V}_{f} {E}_{f}} + \frac{{E}_{c} {τ}_{f}^{2} ( T )}{{r}_{f} {V}_{m} {E}_{m} {E}_{f}} {ξ}^{2} ( T ) + \frac{{E}_{c} {τ}_{f} ( T ) {τ}_{i} ( T )}{ρ {V}_{m} {E}_{m} {E}_{f}} ξ ( T ) - \frac{{τ}_{f} ( T ) σ}{{V}_{f} {E}_{f}} ξ ( T ) + \frac{{r}_{f} {V}_{m} {E}_{m} {σ}^{2}}{4 {χ}^{2} {V}_{f}^{2} {E}_{f} {E}_{c}} - {ζ}_{d} = 0 ; \qquad Formula 2$$
in Formula 2, l_{d} represents the debonding length of the fiber/matrix interface;
ξ(T) represents the length of the oxidation region at the fiber/matrix interface under a temperature condition;
Eₘ represents an elastic modulus of the matrix;
E_{f} represents an elastic modulus of the fiber;
E_{c} represents an elastic modulus of the woven ceramic-matrix composite; and
ζ_{d} represents a debonding energy at the fiber/matrix interface.

5. The method according to claim 3, wherein the criterion of fracture mechanics in the step (2) is shown in Formula 2-1:
$${ζ}_{d} = \frac{F}{4 π {r}_{f}} \frac{\partial {w}_{f} ( 0 )}{\partial {l}_{d}} - \frac{1}{2} {\int }_{0}^{{l}_{d}} {τ}_{i} ( x ) \frac{\partial v ( x )}{\partial {l}_{d}} dx \qquad Formula 2 \text{-} 1$$
an axial displacement of the fiber is shown in Formula 2-2:
$${w}_{f} ( x ) = \frac{σ}{χ {V}_{f} {E}_{f}} ( {l}_{d} - x ) - \frac{{τ}_{f} ( T )}{{r}_{f} {E}_{f}} ( 2 ξ ( T ) {l}_{d} - {ξ}^{2} ( T ) - {x}^{2} ) - \frac{{τ}_{i} ( T )}{{r}_{f} {E}_{f}} {( {l}_{d} - ξ )}^{2} + \frac{{σ}_{fo}}{{E}_{f}} ( \frac{{l}_{c}}{2} - {l}_{d} ) + \frac{{r}_{f}}{ρ {E}_{f}} [ \frac{{V}_{m}}{χ {V}_{f}} {σ}_{mo} - \frac{2 {τ}_{f} ( T )}{{r}_{f}} ξ ( T ) - \frac{2 {τ}_{i} ( T )}{{r}_{f}} ( {l}_{d} - ξ ( T ) ) ] [ 1 - exp ( - ρ \frac{{l}_{c} / 2 - {l}_{d}}{{r}_{f}} ) ] ; \qquad Formula 2 \text{-} 2$$
an axial displacement of the fiber relative to the matrix is shown in Formula 2-3:
$$v ( x ) = \frac{σ}{χ {V}_{f} {E}_{f}} ( {l}_{d} - x ) - \frac{{E}_{c} {τ}_{f} ( T )}{{r}_{f} {V}_{m} {E}_{m} {E}_{f}} ( 2 ξ ( T ) {l}_{d} - {ξ}^{2} ( T ) - {x}^{2} ) - \frac{{E}_{c} {τ}_{i} ( T )}{{r}_{f} {V}_{m} {E}_{m} {E}_{f}} {( {l}_{d} - ξ ( T ) )}^{2} + \frac{{r}_{f} {E}_{c}}{ρ {V}_{m} {E}_{m} {E}_{f}} [ {σ}_{mo} - 2 \frac{{τ}_{f} ( T )}{{r}_{f}} ξ ( T ) - 2 \frac{{τ}_{i} ( T )}{{r}_{f}} ( {l}_{d} - ξ ( T ) ) ] [ 1 - exp ( - ρ ( \frac{{l}_{c} / 2 - {l}_{d}}{{r}_{f}} ) ] ; \qquad Formula 2 \text{-} 3$$
in the formulas 2-1, 2-2 and 2-3,
F represents a load carried by the fiber at a crack plane of the matrix;
$$\frac{\partial {w}_{f} ( 0 )}{\partial {l}_{d}}$$
represents deriving the debonding length of the fiber/matrix interface when x in the axial displacement of the fiber is 0;
$$\frac{\partial v ( x )}{\partial {l}_{d}}$$
represents deriving the debonding length of the fiber/matrix interface when x in the axial displacement of the fiber relative to the matrix is 0;
w_{f}(x) represents the axial displacement of the fiber;
v(x) represents the axial displacement of the fiber relative to the matrix;
l_{c} represents a crack spacing of the matrix;
τ_{f}(T) represents a frictional shear stress of the oxidation region at the fiber/matrix interface under a temperature condition; and
τᵢ(T) represents a frictional shear stress of the slip region at the fiber/matrix interface under a temperature condition.

6. The method according to claim 4, wherein the criterion of fracture mechanics in the step (2) is shown in Formula 2-1:
$${ζ}_{d} = \frac{F}{4 π {r}_{f}} \frac{\partial {w}_{f} ( 0 )}{\partial {l}_{d}} - \frac{1}{2} {\int }_{0}^{{l}_{d}} {τ}_{i} ( x ) \frac{\partial v ( x )}{\partial {l}_{d}} dx \qquad Formula 2 \text{-} 1$$
an axial displacement of the fiber is shown in Formula 2-2:
$${w}_{f} ( x ) = \frac{σ}{χ {V}_{f} {E}_{f}} ( {l}_{d} - x ) - \frac{{τ}_{f} ( T )}{{r}_{f} {E}_{f}} ( 2 ξ ( T ) {l}_{d} - {ξ}^{2} ( T ) - {x}^{2} ) - \frac{{τ}_{i} ( T )}{{r}_{f} {E}_{f}} {( {l}_{d} - ξ )}^{2} + \frac{{σ}_{fo}}{{E}_{f}} ( \frac{{l}_{d}}{2} - {l}_{d} ) + \frac{{r}_{f}}{ρ {E}_{f}} [ \frac{{V}_{m}}{χ {V}_{f}} {σ}_{mo} - \frac{2 {τ}_{f} ( T )}{{r}_{f}} ξ ( T ) - \frac{2 {τ}_{i} ( T )}{{r}_{f}} ( {l}_{d} - ξ ( T ) ) ] [ 1 - exp ( - ρ ( \frac{{l}_{c} / 2 - {l}_{d}}{{r}_{f}} ) ] ; \qquad Formula 2 \text{-} 2$$
an axial displacement of the fiber relative to the matrix is shown in Formula 2-3:
$$v ( x ) = \frac{σ}{χ {V}_{f} {E}_{f}} ( {l}_{d} - x ) - \frac{{E}_{c} {τ}_{f} ( T )}{{r}_{f} {V}_{m} {E}_{m} {E}_{f}} ( 2 ξ ( T ) {l}_{d} - {ξ}^{2} ( T ) - {x}^{2} ) - \frac{{E}_{c} {τ}_{i} ( T )}{{r}_{f} {V}_{m} {E}_{m} {E}_{f}} {( {l}_{d} - ξ ( T ) )}^{2} + \frac{{r}_{f} {E}_{c}}{ρ {V}_{m} {E}_{m} {E}_{f}} [ {σ}_{mo} - 2 \frac{{τ}_{f} ( T )}{{r}_{f}} ξ ( T ) - 2 \frac{{τ}_{i} ( T )}{{r}_{f}} ( {l}_{d} - ξ ( T ) ) ] [ 1 - exp ( - ρ ( \frac{{l}_{c} / 2 - {l}_{d}}{{r}_{f}} ) ] ; \qquad Formula 2 \text{-} 3$$
in the formulas 2-1, 2-2 and 2-3,
F represents a load carried by the fiber at a crack plane of the matrix;
$$\frac{\partial {w}_{f} ( 0 )}{\partial {l}_{d}}$$
represents deriving the debonding length of the fiber/matrix interface when x in the axial displacement of the fiber is 0;
$$\frac{\partial v ( x )}{\partial {l}_{d}}$$
represents deriving the debonding length of the fiber/matrix interface when x in the axial displacement of the fiber relative to the matrix is 0;
w_{f}(x) represents the axial displacement of the fiber;
v(x) represents the axial displacement of the fiber relative to the matrix;
l_{c} represents a crack spacing of the matrix;
τ_{f}(T) represents a frictional shear stress of the oxidation region at the fiber/matrix interface under a temperature condition; and
τᵢ(T) represents a frictional shear stress of the slip region at the fiber/matrix interface under a temperature condition.

7. The method according to claim 1, wherein the unloading counter slip length equation is preferably shown in Formula 3:
$$y = \frac{1}{2} \{ {l}_{d} + ( 1 - \frac{{τ}_{f} ( T )}{{τ}_{i} ( T )} ) ξ - [ \frac{{r}_{f}}{2} ( \frac{{V}_{m} {E}_{m}}{χ {V}_{f} {E}_{c}} \frac{σ}{{τ}_{i} ( T )} - \frac{1}{ρ} ) - \sqrt{{( \frac{{r}_{f}}{2 ρ} )}^{2} + \frac{{r}_{f} {V}_{m} {E}_{m} {E}_{f}}{{E}_{c} {τ}_{i}^{2} ( T )} {ζ}_{c}} ] \} ; \qquad Formula 3$$
in Formula 3, y represents an unloading counter slip length.

8. The method according to claim 1, wherein the reloading new slip length equation of the fiber/matrix interface is preferably shown in Formula 4:
$$z = \frac{{τ}_{i} ( T )}{{τ}_{f} ( T )} \{ y - \frac{1}{2} [ {l}_{d} + ( 1 - \frac{{τ}_{f} ( T )}{{τ}_{i} ( T )} ) ξ ( T ) - [ \frac{{r}_{f}}{2} ( \frac{{V}_{m} {E}_{m}}{χ {V}_{f} {E}_{c}} \frac{σ}{{τ}_{i} ( T )} - \frac{1}{ρ} ) - \sqrt{{( \frac{{r}_{f}}{2 ρ} )}^{2} + \frac{{r}_{f} {V}_{m} {E}_{m} {E}_{f}}{{E}_{c} {τ}_{i}^{2} ( T )} {ζ}_{d}} ] ] \} ; \qquad Formula 4$$
in Formula 4, z represents a reloading new slip length of the fiber/matrix interface.

9. The method according to claim 7, wherein the reloading new slip length equation of the fiber/matrix interface is preferably shown in Formula 4:
$$z = \frac{{τ}_{i} ( T )}{{τ}_{f} ( T )} \{ y - \frac{1}{2} [ {l}_{d} + ( 1 - \frac{{τ}_{f} ( T )}{{τ}_{i} ( T )} ) ξ ( T ) - [ \frac{{r}_{f}}{2} ( \frac{{V}_{m} {E}_{m}}{χ {V}_{f} {E}_{c}} \frac{σ}{{τ}_{i} ( T )} - \frac{1}{ρ} ) - \sqrt{{( \frac{{r}_{f}}{2 ρ} )}^{2} + \frac{{r}_{f} {V}_{m} {E}_{m} {E}_{f}}{{E}_{c} {τ}_{i}^{2} ( T )} {ζ}_{d}} ] ] \} ; \qquad Formula 4$$
in Formula 4, z represents a reloading new slip length of the fiber/matrix interface.

10. The method according to claim 1, wherein the unloading stress-strain equation is preferably shown in Formula 5-1:
$${ɛ}_{unloading} ( σ ) = \frac{2 σ {l}_{d}}{χ {V}_{f} {E}_{f} {l}_{c}} + \frac{2 {τ}_{f} ( T )}{{r}_{f} {E}_{f} {l}_{c}} {ξ}^{2} + \frac{4 {τ}_{f} ( T )}{{r}_{f} {E}_{f} {l}_{c}} ξ ( T ) ( {l}_{d} - ξ ( T ) ) + \frac{4 {τ}_{i} ( T )}{{r}_{f} {E}_{f} {l}_{c}} {( y - ξ ( T ) )}^{2} - \frac{2 {τ}_{i} ( T )}{{r}_{f} {E}_{f} {l}_{c}} {( 2 y - ξ ( T ) - {l}_{d} )}^{2} + \frac{2 {σ}_{fo}}{{E}_{f} {l}_{c}} ( \frac{{l}_{c}}{2} - {l}_{d} ) + \frac{2 {r}_{f}}{ρ {E}_{f} {l}_{c}} [ \frac{{V}_{m}}{χ {V}_{f}} {σ}_{mo} + \frac{2 {τ}_{f} ( T )}{{r}_{f}} ξ ( T ) + \frac{2 {τ}_{i}}{{r}_{f}} ( 2 y - ξ ( T ) - {l}_{d} ) ] \times [ 1 - exp ( - ρ \frac{{l}_{c} / 2 - {l}_{d}}{{r}_{f}} ) ] - ( {α}_{c} - {α}_{f} ) Δ T ; \qquad Formula 5 \text{-} 1$$
the reloading stress-strain equation is preferably shown in Formula 5-2:
$${ɛ}_{reloading} ( σ ) = \frac{2 σ}{χ {V}_{f} {E}_{f} {l}_{c}} {l}_{d} - \frac{4 {τ}_{f} ( T )}{{r}_{f} {E}_{f} {l}_{c}} {z}^{2} + \frac{2 {τ}_{f} ( T )}{{r}_{f} {E}_{f} {l}_{c}} {( 2 z - ξ ( T ) )}^{2} - \frac{4 {τ}_{f} ( T )}{{r}_{f} {E}_{f} {l}_{c}} ( 2 z - ξ ( T ) ) ( {l}_{d} - ξ ( T ) ) + \frac{4 {τ}_{i} ( T )}{{r}_{f} {E}_{f} {l}_{c}} {( y - ξ ( T ) )}^{2} - \frac{2 {τ}_{i} ( T )}{{r}_{f} {E}_{f} {l}_{c}} {( 2 y - ξ ( T ) - {l}_{d} )}^{2} + \frac{2 {σ}_{fo}}{{E}_{f} {l}_{c}} ( \frac{{l}_{c}}{2} - {l}_{d} ) + \frac{2 {r}_{f}}{ρ {E}_{f} {l}_{c}} [ \frac{{V}_{m}}{χ {V}_{f}} {σ}_{mo} - \frac{2 {τ}_{f} ( T )}{{r}_{f}} ( 2 z - ξ ( T ) ) + \frac{2 {τ}_{i} ( T )}{{r}_{f}} ( 2 y - ξ ( T ) - {l}_{d} ) ] \times [ 1 - exp ( - ρ \frac{{l}_{c} / 2 - {l}_{d}}{{r}_{f}} ) ] - ( {α}_{c} - {α}_{f} ) Δ T ; \qquad Formula 5 \text{-} 2$$
in the formulas 5-1 and 5-2, ε_{unloading}(σ) represents a strain corresponding to an unloading stress; and
ε_{reloading}(σ) represents a strain corresponding to a reloading stress.

11. The method according to claim 1, wherein the fatigue hysteresis dissipated energy equation is preferably shown in Formula 6:
$$U = {\int }_{{σ}_{min}}^{{σ}_{max}} [ {ɛ}_{unloading} ( σ ) - {ɛ}_{reloading} ( σ ) ] d σ ; \qquad Formula 6$$
in Formula 6, U represents a fatigue hysteresis dissipated energy;
σₘₐₓ represents a fatigue peak stress; and
σₘᵢₙ represents a fatigue valley stress.

12. The method according to claim 10, wherein the fatigue hysteresis dissipated energy equation is preferably shown in Formula 6:
$$U = {\int }_{{σ}_{min}}^{{σ}_{max}} [ {ɛ}_{unloading} ( σ ) - {ɛ}_{reloading} ( σ ) ] d σ ; \qquad Formula 6$$
in Formula 6, U represents a fatigue hysteresis dissipated energy;
σₘₐₓ represents a fatigue peak stress; and
σₘᵢₙ represents a fatigue valley stress.
